(19) United States
(12) Patent Application Publication
(10) Pub. No.: US 2004/0202836 A1
(43) Pub. Date: Oct. 14, 2004

(54) Pre-perforated ink-jet media for printer customization

(76) Inventor: Shawn M. Close, Vancouver, WA (US)

Correspondence Address: HEWLETT-PACKARD COMPANY, Intellectual Property Administration, P.O. Box 272400, Fort Collins, CO, 80527-2400, US

(21) Appl. No.: 10/262,027

(22) Filed: Sep. 30, 2002

(51) Int. Cl. B41M 5/00; B32B 3/00

(52) U.S. Cl. 428/195.1; 428/304.4; 428/312.2; 428/43; 347/105

(57) ABSTRACT

An ink-jet ink media sheet can include a specialty media coating configured for receiving ink-jet ink, wherein the media sheet has perforations therethrough that at least partially define a non-rectangular predetermined shape. A customization system for electronic components is also disclosed that can use the ink-jet media sheet described above, or another media sheet, which includes, an electronic component having a display space of a first configuration for receiving a printed media sheet of a predetermined shape; and a media sheet having perforations defining the predetermined shape, wherein upon tearing along the perforations, the predetermined shape is formable. In one embodiment, a printed predetermined shape forms a selected media image or skin that can be placed in the display space.

### FIELD OF THE INVENTION

The present invention relates generally to perforated ink-jet media, systems for customizing personal electronic components such as printers, and methods for creating uniquely sized ink-jet ink produced images.

### BACKGROUND OF THE INVENTION

Ink-jet inks typically comprise an ink vehicle and a colorant, the latter of which may be a dye or a pigment. Specialized ink-jet media has been developed that interacts favorably with ink-jet inks. Because of these advancements, many ink-jet ink images printed on specialized ink-jet media can be made to perform comparably with traditional silver halide photography prints, particularly when an appropriate media and ink are selected for use together. A few categories of photographic ink-jet media are currently available, including polymeric water swellable-coated media and inorganic porous coated media. As there has been great interest and improvement in the area of ink-jet media, there is a great desire to increase the number of applications of use for this type media.

### SUMMARY OF THE INVENTION

It has been recognized that it would be advantageous to develop perforated ink-jet media, systems for customizing electronic components such as printers, and methods for creating uniquely sized ink-jet ink produced images. More specifically, the present invention provides a customization system for customizing electronic components and ink-jet media sheets.

In one embodiment, the invention provides an ink-jet ink media sheet including a specialty media coating configured for receiving ink-jet ink, wherein the media sheet has perforations therethrough that at least partially define a non-rectangular predetermined shape. In one embodiment, the perforations can be multi-angular and/or arcuate.

Additionally, a customization system for electronic components can comprise a electronic component having a display space of a first configuration for receiving a printed media sheet of a predetermined shape; and a media sheet having perforations defining the predetermined shape, wherein upon tearing along the perforations, the predetermined shape is formable. As a non-limiting example, the electronic component can be any computer peripheral, such as a printer, monitor, digital camera, speaker, gaming control, mouse, keyboard, hardware casing, scanner, or the like. In one embodiment, a printer can be the electronic component that is customizable, and further, the printer itself can be configured to print on the media sheet of the predetermined shape. As an example of one embodiment of the invention, the display space can be partially defined by a see-through cover that provides a viewable window to the display space. Such a viewable window can include a see-through cover connected to the printer, such as by a hinge, or by some other connecting means.

In another embodiment, a method of creating a uniquely sized ink-jet ink produced image can comprise the steps of providing a media sheet having perforations therethrough that at least partially defines a non-rectangular predetermined shape; ink-jet printing on the media sheet within the predetermined shape; and tearing the predetermined shape from the media sheet along the perforations. In one embodiment, the perforations can be multi-angular and/or arcuate.

In each of the above embodiments, the media sheet can include a specialty media coating. Exemplary coatings include polymeric swellable media coatings or inorganic porous media coatings, as are known in the art. Further, the predetermined shape can be defined by perforations configured in straight lines, curved lines, or a combination of straight lines and curved lines. Because the tearing of a predetermined shape that is totally defined by perforations is difficult to start, at least one segment of the perforations can extend to at least one edge or border of the media sheet, thereby providing an easy starting point for tearing. If a predetermined shape is not totally defined by the perforations, i.e., the border of the media sheet partially defines the predetermined shape, a starter perforation extending to the edge is not necessary, though one can be included if desired. No matter what predetermined shape is used, once printed upon, the predetermined shape can be torn from the media sheet and used as a skin beneath a clear cover of a electronic component, such as a printer, thereby allowing for the customization of the look of the electronic component.

For the sake of brevity, a printed image within the perforations defining the predetermined shape, or separated from the media sheet along the perforations, can be referred to simply as a “selected media image” or as a “skin.”

Additional features and advantages of the invention will be apparent from the detailed description which follows, taken in conjunction with the accompanying drawings, which together illustrate, by way of example, features of the invention.

### DESCRIPTION OF THE FIGURES

FIG. 1 is a perspective view of a printer having a see-though cover configured in an open position in accordance with an embodiment of the present invention;

FIG. 2 is a front view of a media sheet, which is an embodiment of the invention, having perforations defining a predetermined shape, and having an image printed on the predetermined shape, thereby defining a selected media image within the perforation lines;

FIG. 3 is a perspective view of the selected media image, which is an embodiment of the invention, of FIG. 2 which has been separated from the media sheet and contained beneath the closed see-through cover of the printer of FIG. 1;

FIG. 4 is a front view of a media sheet, which is an embodiment of the invention, having various non-rectangular predetermined shapes defined by perforations that are non-rectangular and/or arcuate; and

FIG. 5 is a front view of an alternative media sheet, which is an embodiment of the invention, having multiple non-rectangular predetermined shapes, each being defined, at least in part, by multi-angular and/or arcuate perforations.

### DETAILED DESCRIPTION OF THE PREFERRED EMBODIMENT(S)

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

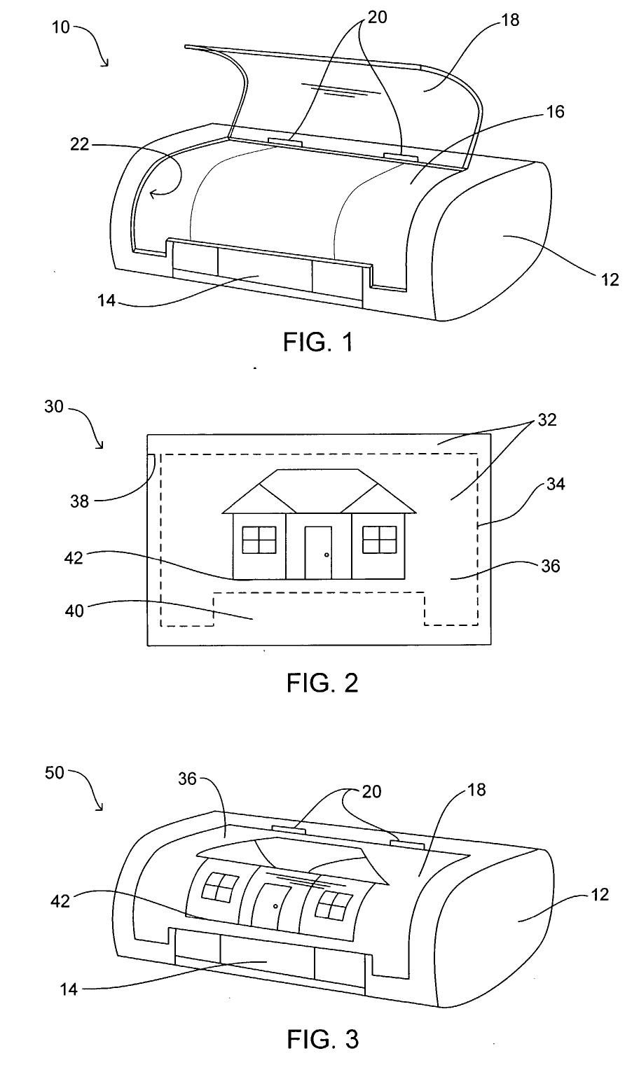

As illustrated in FIG. 1, a system, indicated generally at 10, in accordance with the present invention is shown for a printer, preferably an ink-jet printer, configured for personalization. Specifically, the printer comprises a housing 12 that supports an extendable paper or media tray 14. The media tray 14 can be used to both feed ink-jet media (not shown) for printing, and/or receive printed media (not shown) once an image is printed. Methods of ink-jet printing, as well as acceptable ink-jet inks and internal hardware within the housing, are well known in the art.

In the embodiment shown, the housing 12 includes a recessed selected media image display surface 16 and a see-through cover 18. The see-through cover 18 is in an open position and is attached to the housing 12 by a pair of hinges 20. The term “see-through” includes any member, such as a cover, that is not completely opaque, such as clear covers, translucent covers, colored non-opaque covers, smoked covers, and the like. When the see-through cover 18 is in a closed position (not shown), the see-through cover 18 and the recessed surface 16 provide a space 22. The space 22 between the cover 18 and the recessed surface 16 is large enough to accommodate at least the thickness of a selected media image (not shown).

FIG. 2 shows a printed ink-jet media sheet 30, which can include a specialty media coating 32, such as polymeric swellable media coating or an inorganic porous media coating that is configured for receiving ink-jet ink. The media sheet 30 also includes perforations 34 through the media sheet 30 that at least partially define a non-rectangular predetermined shape 36 that is also multi-angular. Specifically, the non-rectangular predetermined shape shown is a polygonal shape having eight right-angles. The perforation line is also multi-angular. However, any shape, including rectangular or square shapes can be perforated into a media sheet 30 for printer customization. Though not shown in this embodiment, the predetermined shape 36 can be a shape that includes one or more arcuate perforation line(s).

As the predetermined shape 36 in the embodiment shown is totally within the boundaries of the media sheet, a starter perforation 38 is present to provide easy tearing access to the perforations 34 that define the predetermined shape 36. Once the predetermined shape is torn from the printed media sheet 30, excess media material 40 can be discarded. In some embodiments, the excess media material 40 can provide a second desired predetermined shape (not shown).

Printed on the media sheet 30 is an image 42 that is at least partially printed within the predetermined shape 36 defined by the perforations 34, thereby forming the selected media image. By providing a pre-perforated media sheet 30 that is substantially rectangular, a conventional ink-jet printer can accommodate the printing of a personalized image, which can subsequently be torn along the perforations to provide a customized selected media image shape.

In FIG. 3, a system 50 that combines the use of a printed media sheet 30 of FIG. 2 and the printer 10 of FIG. 1 is shown. Specifically, the printed media sheet 30 of FIG. 2 can be torn along its perforations 34 to form a predetermined shape 36 having a selected media image 42 printed thereon. In other words, when the printed media sheet 30 of the predetermined shape 36 is printed on and torn from the perforations, the resulting selected media image is configured to be used as a skin beneath a see-through cover 18 of a printer, thereby allowing for the customization of the look of the printer. The cover 18 is shown in a closed position, wherein a display space (not shown) remains between the cover 18 and the recessed media image display surface (not shown) containing the selected media image that has been separated from the media sheet along the perforations. The recessed surface (not shown) also provides support to the printed media sheet 30 of the predetermined shape 36. As in FIG. 1, a housing 12, a media tray 14, and hinges 20 are also shown.

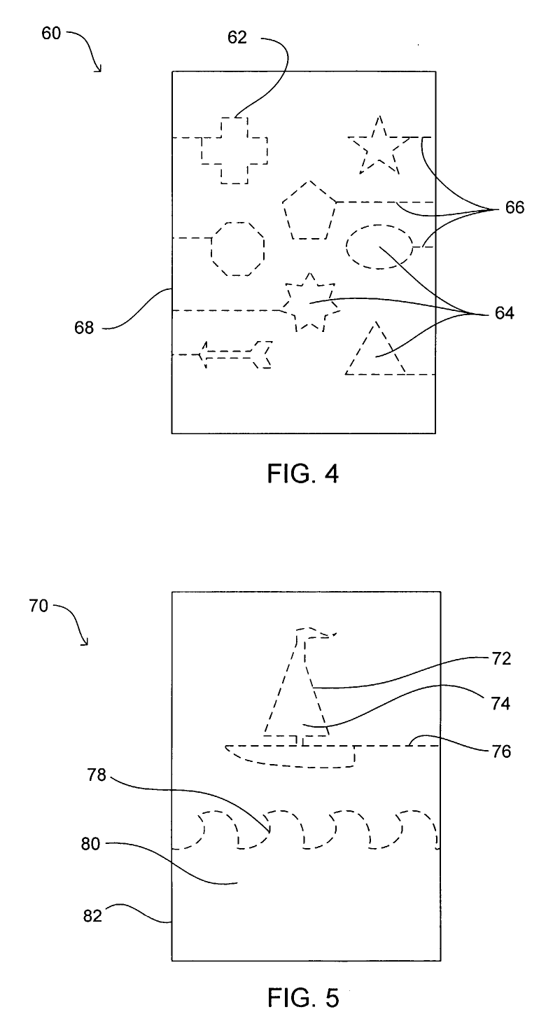

Turning now to FIG. 4, a media sheet 60 is shown having perforations 62 that define a variety of shapes 64. Though many different shapes are shown, such as those having straight boundaries, curved boundaries, or a combination of straight and curved boundaries, other shapes can also be used. For example, a single large shape, a plurality of shapes of common dimension, a plurality of different shapes, and the like, could be configured for use. A commonality is that each shape is multi-angular or arcuate in shape. Alternatively, each shape can be characterized as non-rectangular. Each of the shapes 64 shown all have a starter perforation 66 that extends from its shape to a border 68 of the media sheet 60. The starter perforation 66 can facilitate easier tearing of the predetermined shape 64 by a user.

FIG. 5 provides another embodiment, wherein a media sheet 70 includes perforations 72 that define a predetermined shape 74, which in this embodiment, is in the shape of a sailboat. This illustrates that the perforations 72 can define more complicated shapes than simple polygonal or curved shapes. Again, a starter perforation 76 is present to provide for easy tearing of the predetermined shape 74 from the media sheet 70.

Also shown on media sheet 70 is a predetermined shape 80 that is partially defined by the perforations 78, and partially defined by an outer border or edge 82 of the media sheet 70. No starter perforation is necessary, as the perforations 78 that partially define the predetermined shape inherently extend to the outer border 82.

FIG. 5 illustrates that the perforations 72 can either define the entire predetermined shape 74, or alternatively, the predetermined shape 80 can be partially defined by an outer border 82, and partially by the perforations 78 of the media sheet 70. The predetermined shapes shown in FIGS. 4-5, or any other conceivable shape that can be perforated into a media sheet, can be included within a display opening or display space of an electronic component, such as a printer.

In addition to the media sheets and systems described in FIGS. 1-5, various methods can be implemented in accordance with embodiments of the present invention. Specifically, a method of creating a uniquely sized ink-jet ink produced image can comprise the steps of providing a media sheet having perforations therethrough that at least partially defines a non-rectangular predetermined shape; ink-jet printing on the media sheet within the predetermined shape; and tearing the predetermined shape from the media sheet along the perforations. In another embodiment, the predetermined shape can be defined by multi-angular and/or arcuate perforations.

With respect to each of the embodiments described herein, i.e., media sheets, systems, and methods, if a specialty media coating is used, it can be specifically configured for receiving ink-jet ink. For example, a polymeric swellable media coating, or an inorganic porous media coating can be used. Further, the step of ink-jet printing can be by any ink-jet ink composition that is effective for printing on media, including dye- and pigment-based ink-jet ink. The predetermined shape can include straight lines, curved lines, or a combination thereof. Additionally, in one embodiment, at least one segment of the perforations can extend to at least one edge of the media sheet, thereby providing an easy starting point for tearing. Alternatively, the perforations can define the entire predetermined shape. Still further, in another embodiment, the predetermined shape can be at least partially defined an outer border of the media sheet. No matter what predetermined shape is provided and printed on, the shape can be torn from the rest of the media sheet and placed in a display space of an electronic component to thereby customize the look of the electronic component. Though a printer has specifically been shown as a preferred electronic component, others can be used, including a monitor, digital camera, video camera, speaker, gaming control, mouse, keyboard, hardware casing, scanner, or the like.

There are several advantages provided by embodiments of the present invention. The customization of a printer with a personalized printed skin will be considered below by example, though any electronic component can be customized similarly. By providing multiple sheets of predetermined shape-containing pre-perforated ink-jet media with an ink-jet printer, images configured for decorating a printer can be created and changed at any time. To change an image, the user can simply generate a new image on another media sheet, tear the predetermined shape from the media sheet, remove an existing predetermined shape having the old image printed thereon from the printer display space, and replace it with the new selected media image having the selected predetermined shape.

As another advantage, a media printed skin of a profile configured to fit into a display space of the printer does not have to be cut out by hand, such as with scissors. The perforation lines allow the customer to print the image (using included software in one embodiment) and then immediately tear off the edges of the sheet by hand. Because no scissors are required, careful cutting of the edges is not required. Not having to use a cutting tool makes the process quicker and easier for printer personalization. It also makes the process safer for children.

To illustrate other advantages of the present invention, in the embodiment shown in FIGS. 1-3, the shape of the predetermined shape can be very precise. Because the perforation profiles are generally created using automated processes, the final shape of the insert (or skin) can be very consistent. If a skin of a predetermined shape were to be cut by hand, mistakes can easily be made. For example, cutting the shape too small will cause the skin to fit loosely within the display space of the printer. If the skin is cut too large, the skin of the predetermined shape may not fit beneath the cover of the display space at all. This being stated, the invention does not require that the skin fit within the display space precisely. For example, certain applications may be desirable wherein a loose-fitting skin is present beneath a see-through cover of an electronic component.

When considering what type of media sheet to use in accordance with embodiments of the present invention, the use of any functional media sheet can be implemented. However, the perforation process by a machine or automated system is typically more difficult on very thin sheets of media, or on plain paper, though these types of media and papers are not excluded for use with embodiments the present invention.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. An ink-jet ink media sheet including a specialty media coating configured for receiving ink-jet ink, said media sheet having perforations therethrough that at least partially define a non-rectangular predetermined shape.

2. An ink-jet media sheet as in claim 1, wherein the specialty media coating is a polymeric swellable media coating.

3. An ink-jet media sheet as in claim 1, wherein the specialty media coating is an inorganic porous media coating.

4. An ink-jet media sheet as in claim 1, wherein the predetermined shape is at least partially defined by arcuate lines.

5. An ink-jet media sheet as in claim 1, wherein the predetermined shape is at least partially defined by multi-angular line.

6. An ink-jet media sheet as in claim 1, wherein at least one segment of the perforations extend to at least one edge of the media sheet, thereby providing an easy starting point for tearing.

7. An ink-jet media sheet as in claim 1, wherein the perforations define the entire predetermined shape.

8. An ink-jet media sheet as in claim 1, wherein the predetermined shape is at least partially defined by an outer border of the media sheet.

9. An ink-jet media sheet as in claim 1, wherein the predetermined shape, once printed upon, is configured to be torn from the media sheet and used as a skin in a display space of a printer, thereby allowing for the customization of a look of the printer.

10. A customization system for electronic components, comprising:
an electronic component having a display space configured for receiving a printed media sheet of a predetermined shape; and
a media sheet having perforations defining the predetermined shape, wherein upon tearing along the perforations, the predetermined shape is formable.

11. A customization system as in claim 10, wherein the electronic component is a printer.

12. A customization system as in claim 11, wherein the display space is further defined by a see-through cover that provides a viewable window to the display space.

13. A customization system as in claim 10, further comprising software configured for enabling a user to print on the media sheet at least in part within the predetermined shape.

14. A customization system as in claim 10, wherein the media sheet is coated with a composition configured for receiving ink-jet ink.

15. A customization system as in claim 14, wherein the coating is selected from the group consisting of a polymeric swellable coating and an inorganic porous coating.

16. A customization system as in claim 11, wherein the printer is an ink-jet printer.

17. A customization system as in claim 10, wherein the media sheet has been printed on by the printer and the perforations have been torn to form a selected media image, and wherein the selected media image is placed in the display space.

18. A customization system as in claim 10, wherein the predetermined shape is at least partially defined by an arcuate perforation line.

19. A customization system as in claim 10, wherein the predetermined shape is at least partially defined by a multi-angular perforation line.

20. A customization system as in claim 10, wherein at least one segment of the perforations extends to at least one edge of the media sheet, thereby providing an easy starting point for tearing.

21. A customization system as in claim 10, wherein the perforations define the entire predetermined shape.

22. A customization system as in claim 10, wherein the predetermined shape is at least partially defined by an outer border of the media sheet.

23. A customization system as in claim 10, wherein the predetermined shape is non-rectangular.

24. A customization system as in claim 10, wherein the predetermined shape is configured to substantially match dimensions of the display space such that the predetermined shape fits entirely within the display space.

25. A method of creating a uniquely sized, ink-jet ink produced image, comprising:
providing a media sheet having perforations therethrough that at least partially defines a non-rectangular predetermined shape;
ink-jet printing on the media sheet within the predetermined shape; and
tearing the predetermined shape from the media sheet along the perforations.

26. A method as in claim 25, wherein the media sheet includes a specialty media coating specifically configured for receiving ink-jet ink.

27. A method as in claim 26, wherein the specialty media coating is selected from the group consisting of a polymeric swellable media coating and an inorganic porous media coating.

28. A method as in claim 25, wherein the step of ink-jet printing is by a dye- or pigment-based ink-jet ink.

29. A method as in claim 25, wherein the predetermined shape is at least partially defined by an arcuate perforation line.

30. A method as in claim 25, wherein the predetermined shape is at least partially defined by a multi-angular perforation line.

31. A method as in claim 25, wherein at least one segment of the perforations extend to at least one edge of the media sheet, thereby providing an easy starting point for tearing.

32. A method as in claim 25, wherein the perforations define the entire predetermined shape.

33. A method as in claim 25, wherein the predetermined shape is at least partially defined by an outer border of the media sheet.

34. A method as in claim 25, further comprising the step of providing a printer having a display space configured for receiving a printed media sheet of the predetermined shape.

35. A method as in claim 25, wherein the display space is configured to substantially match and receive the predetermined shape such that the predetermined shape fits entirely within the display space.
